(19) United States
(12) Patent Application Publication
(10) Pub. No.: US 2010/0068348 A1
(43) Pub. Date: Mar. 18, 2010

(54) Food Systems

(75) Inventors: Curtis Cundith, Wichita, KS (US); William Arthur Buckner, Wayzata, MN (US)

Correspondence Address: CARGILL, INCORPORATED, P.O. Box 5624, MINNEAPOLIS, MN, 55440-5624, US

(73) Assignee: CARGILL, INCORPORATED, Wayzata, MN (US)

(21) Appl. No.: 12/448,496

(22) PCT Filed: Dec. 20, 2007
(86) PCT No.: PCT/US07/26057

§ 371 Date: Nov. 23, 2009

Related U.S. Application Data
(60) Provisional application No. 60/871,512, filed on Dec. 22, 2006.

(51) Int. Cl. A23L 1/22; B65D 81/00; A23L 1/31; A23L 1/00

(52) U.S. Cl. 426/87; 426/132; 426/124; 426/392

(57) ABSTRACT

Kits comprising a food product and a wooden support member are provided. The support member is preferably configured to support and provide flavor to the food product during cooking. A food product package for retail distribution preferably includes a food product, a wooden support member, and a packaging material containing the support member and the food product. Methods for packaging a food product for retail distribution are also provided and preferably include providing a food product, providing a wooden support member configured to support and flavor the food product during cooking of the food product, and packaging the support member and the food product together for retail distribution.

### CROSS-REFERENCE TO RELATED APPLICATION

The present application claims the benefit of PCT Patent Application Serial No. PCT/US2007/026057 filed Dec. 20, 2007, entitled FOOD SYSTEMS, which claims the benefit of U.S. Provisional Application No. 60/871,512, filed Dec. 22, 2006 entitled FOOD SYSTEMS, which are incorporated herein by reference in their entirety.

### TECHNICAL FIELD

The present invention relates to food product systems and methods. More particularly, the present invention relates to meat product kits, packaging systems, and related methods.

### BACKGROUND

Wooden plank cooking is a popular technique for cooking food products, such as, for example, various meat products. Such plank cooking typically involves placing a food product on a surface of a wooden plank that is positioned over or adjacent to a heat source. Such heat sources include, for example, the burners of an indoor or outdoor grill, the hot coals of a cooking fire, or in a conventional oven. Heat from the heat source causes the wooden plank to partially char, thereby generating smoke that contacts the food product cooking on the surface of the wooden plank. The smoke often provides the food product with a distinctive flavor and appearance. Some of the heat is transferred through the thickness of the wooden plank to the food product positioned on the surface of the plank and can aid in the cooking process. The thickness of the plank functions to protect the food from direct exposure to the heat source, which inhibits burning and minimizes the loss of moisture from the food. Wood species that release flavorful smoke such as, for example, cedar (e.g., western red cedar), alder, apple, cherry, maple, pecan, hickory and mesquite, are particularly suitable for use in plank cooking.

Precut planks of kiln-dried wood are distributed specifically for use in plank cooking. The dimensions (e.g., length, width, thickness) of available precut wooden planks vary. Precut planks are distributed separately from the food for which plank cooking is desired. Accordingly, chefs separately obtain (e.g., purchase) the food product, such as a meat product, for example, for which plank cooking is desired and the wooden plank.

When using precut wooden cooking planks for cooking, the chef generally soaks the planks in a hydrating liquid, typically water, for as long as twenty-four hours or more prior to use. It is desirable for the wooden plank to absorb at least a portion of such liquid prior to cooking to assist in the release of flavorful smoke and steam from the wooden plank and to prevent the plank from igniting during cooking. Soaking wooden planks prior to use is time consuming and, if the planks are large, can be somewhat difficult to do for a typical domestic chef. It is sometimes necessary to flip the planks over during soaking because the planks can be difficult to submerge to ensure that all sides or surfaces are adequately hydrated prior to use. Moreover, some woods are poor absorbers of such hydrating liquids even when soaked for extended periods of time.

Further, in conventional wooden plank cooking techniques, the chef typically prepares the food product as desired, for example, by seasoning, cutting, trimming fat, and or otherwise treating the food product, prior to placing the food product on the wooden plank for cooking. Such preparation includes handling of the food product by the chef. At the very least, because the food product is distributed separately from the wooden plank, the chef typically handles the food product to remove the food product from its packaging and place the food product on the wooden plank.

### SUMMARY

In view of the foregoing, conventional approaches to wooden plank cooking often requires substantial planning and preparation, and therefore can be time-consuming. It is desirable, therefore, to simplify wooden plank cooking by reducing the preparation and/or planning required by conventional approaches. For example, it is desirable to provide a more convenient distribution of wooden cooking planks and the food products for which wooden plank cooking is desired. It is also desirable to provide food products for wooden plank cooking that are prepared for cooking in combination with purchase of the food product, which helps to minimize preparation time by the chef. For example, it is desirable to provide a kit ready for retail distribution to chefs who desire to perform plank cooking of, for example, a meat product. It is also desirable to provide a case-ready packaged food product in combination with a wooden plank for cooking the food product.

Further, it is desirable to reduce or eliminate the need for chefs to perform lengthy hydration steps prior to cooking with wooden planks. It is also desirable to provide a product that reduces or eliminates the need for chef to handle the food product prior to wooden plank cooking, thereby reducing the risk of spreading bacteria and/or germs.

The present invention therefore provides kits that include one or more food product and one or more wooden support members. The support member is preferably configured to support and provide flavor to the food product during cooking.

In other aspects of the present invention, a food product package for retail distribution is provided and includes one or more food products, one or more wooden support members, and packaging material enclosing the support member and the food product. The support member is configured to support and flavor the food product during cooking of the food product.

Methods for packaging food products for retail distribution are also provided in accordance with the present invention and include providing one or more food products, providing one or more wooden support members configured to support and flavor the food products during cooking of the food products, and a step of packaging the support member and the food product together for retail distribution.

### BRIEF DESCRIPTION OF THE DRAWINGS

The accompanying drawings, which are incorporated in and constitute a part of this specification, illustrate exemplary embodiments of the present invention and together with the description herein, serve to explain the principles of the present invention. A brief description of the drawings is as follows:

FIG. 1 is a top view of an exemplary food product kit in accordance with the present invention;

FIG. 2 is a perspective view of the food product kit of FIG. 1;

FIG. 3 is a perspective view of another exemplary food product kit in accordance with the present invention showing, in particular, an optional tray;

FIG. 4 is a perspective view of an exemplary wooden support member in accordance with the present invention showing, in particular, a design shape;

FIG. 5 is a perspective view of another exemplary wooden support member in accordance with the present invention showing, in particular, a surface feature; and

FIG. 6 is a perspective view of yet another exemplary wooden support member in accordance with the present invention showing another surface feature.

### DETAILED DESCRIPTION

In accordance with various exemplary embodiments, the present invention provides food product kits that include a food product for which cooking is desired, such as, for example, a meat product, in combination with a wooden support member configured to support and flavor the food product during cooking. Such kits offer a convenient system ready for retail distribution to chefs who desire to perform plank cooking of, for example, a meat product. In various exemplary embodiments, the wooden support member and the food product are enclosed together in a packaging material. The kit is preferably packaged as a case-ready product in accordance with the present invention. The term case-ready as used herein refers to products that are produced in a centralized facility, and then packaged and shipped in a packaged state and ready for retail display and sale. Although not necessary, case-ready products may be fully labeled and priced ready to go from the container in which they are shipped to the display case at the point of retail distribution. Alternatively, however, case-ready products may require labeling and/or pricing once such products reach the retail distribution level. In general, no preparation other than pricing and labeling is required at the retail distribution level prior to displaying a case-ready product for retail.

As used herein, the term food product refers to any substance capable of being used as a nutriment for human consumption.

As used herein, the term meat product refers to any animal protein, including, but not limited to, for example, poultry, fish, bovine, ovine, porcine, equine, goat, ostrich, buffalo, and any other animal protein product consumable by humans.

As used herein, the term plank cooking refers to any cooking technique wherein a food product is supported by a wooden member that is positioned relative to a heat source used for cooking so the wooden member becomes heated during the cooking of the food supported thereby. The wooden member also preferably produces smoke and/or steam during the cooking process to provide flavor to the food item. The term plank cooking as used herein is not intended to be limited to such cooking techniques wherein the wooden material is in the form of a plank. Rather, wooden members of various sizes, shapes, and configurations may be used to support the food item during plank cooking.

As used herein, the term chef refers to individuals involved in one or more of obtaining, preparing, and cooking food products for domestic and/or professional uses.

Exemplary embodiments of the present invention therefore offer convenient approaches to plank cooking of food products, such as, for example, meat products. In various exemplary embodiments, the systems and methods of the present invention reduce planning and/or preparation time by enabling chefs to purchase the food product and wooden support member together as a packaged item. Moreover, preparation time can be reduced by providing the food product and wooden support member in such a form that additional preparation steps, such as, for example, hydrating the support member and/or seasoning and/or otherwise preparing the food product, are not required to be performed by the chef. By reducing the time to perform food product preparation, the preparation time is correspondingly reduced and simplified. In addition, by eliminating such additional preparation steps, chefs also may not need to handle the food product before cooking the food product, thereby reducing the risk of spreading bacteria and/or germs.

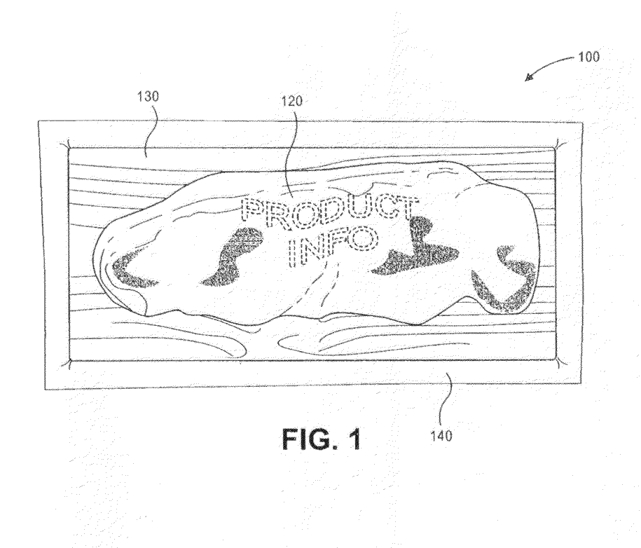

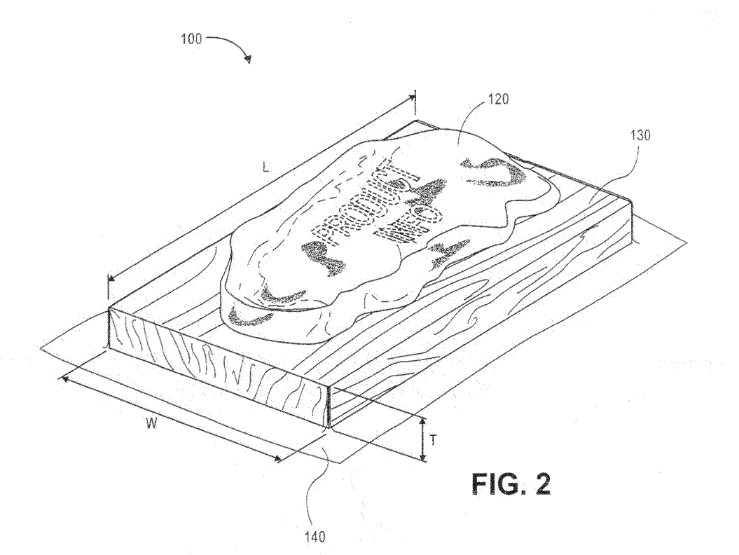

Referring now to FIGS. 1 and 2, an exemplary food product kit 100 in accordance with the present invention is illustrated. As shown, kit 100 includes a food product in the form of a meat product 120 and a wooden support member 130. Plural food products and/or support members may be used. The wooden support member 130 is configured to support the meat product 120 during cooking and also to provide flavor to the meat product 120 during cooking. The wooden support member 130 is preferably in the form of a plank made of any of a variety of various wood species suitable for providing flavor to the meat product 120 due to a release of smoke and/or steam from the wood during cooking. Suitable wood species include, but are not limited to, cedar, alder, apple, cherry, maple, pecan, hickory, and mesquite.

Meat product 120 and wooden support member 130 are preferably packaged together for retail distribution in accordance with the present invention. For example, in the exemplary embodiment shown in FIGS. 1 and 2, the meat product 120 rests on a surface of the wooden support member 130, and the meat product 120 and wooden support member 130 are enclosed in a packaging material 140. The meat product 120 is preferably in a position on the support member 130 ready for cooking upon removal of the packaging material 140. Although the exemplary embodiment shown in FIGS. 1 and 2 shows the meat product 120 being supported by the support member 130 in a position ready for cooking the meat product 120, the support member 130 may be in any suitable position within the packaging material 140. For example, the meat product 120 and support member 130 may be positioned side-by-side, in which case a chef may need to place the meat product 120 onto one of the surfaces of the support member 130 suitable to support the meat product 120 after removal from the packaging material 140 and when plank cooking of the meat product 120 is desired. Further, in various embodiments, the packaging material 140 comprises material suitable for cooking. In other words, the meat product 120, support member 130, and packaging material 140 may together be placed relative to a heat source to perform cooking of the meat product 120. In such embodiments, the packaging material 140 comprises a foil, a bag, or the like known to those having skill in the art for cooking various meat products while enclosed in the outer packaging material.

In accordance with the present invention, the packaging material 140 preferably comprises a transparent or translucent polymeric film, but also could be formed from an opaque metal foil, for example. Combinations of metal and polymeric films can also be used. The packaging material 140 may comprise a plastic material, including, but not limited to, for example, plastic films and/or laminates. Although the packaging material 140 may be wrapped around the meat product 120 and the support member 130 so as to substantially enclose the same without being sealed, in an exemplary aspect, the packaging material 140 may be sealed, for example, to substantially prevent liquid from leaking from the packaging material and/or air from entering the packaging. According to an exemplary embodiment, the meat product 120 and the support member 130 are wrapped in a polymeric film packaging material 140 and the packaging material 140 is vacuum sealed. By way of example only, the packaging material 140 may include any of a variety of packaging products configured for vacuum sealing that are commercially available, such as, for example, packaging products sold under the trademark CRYOVAC®. The meat product 120 and the support member 130 are preferably packaged together by techniques, including, but not limited to modified atmosphere packaging and/or overwrapping with a film, such as a freezable film, for example. Modified atmosphere packaging and/or film overwrapping with a film, such as a freezable film, for example, are known and can be used. Modified atmosphere packaging and/or film overwrapping packaging techniques that can be used with a packaging material for packaging (e.g., enclosing) the meat product 120 and support member 130 are also known and can be used. The packaging material 140 may optionally be provided with a resealing mechanism, such as, for example, resealable mechanisms provided on bags sold under the trademark ZIPLOC®. The packaging material 140 may include a removable portion that can be removed to expose the resealing mechanism, as is used for various cheese and meat products packaged in resealable plastic packages.

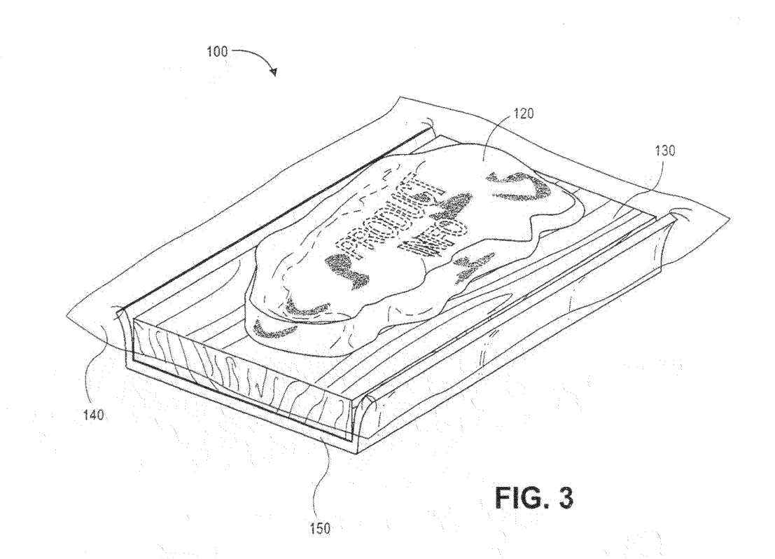

Further, as shown in the exemplary embodiment of FIG. 3, the meat product 120 and the support member 130 are provided in an optional tray 150 shown in a cut-away view of the figure. Suitable trays include barrier trays made of, for example, plastic, Styrofoam, or other materials. The meat product 120, support member 130, and the tray 150 are preferably all be packaged with the packaging material 140, as described above with reference to FIGS. 1 and 2.

Also, a purge pack, or other absorbent pad known to those skilled in the art for packaging meat products, may be packaged with the meat product 120 and support member 130 so as to absorb liquid from the meat product 120. However, when the meat product 120 rests on a surface of the wooden support member 130, as shown in FIGS. 1-3, such an absorbent pad may not be necessary as the support member 130 itself may be configured to absorb liquid from the meat product 120. Eliminating the need for such an absorbent pad helps to reduce preparation and handling of the meat product 120 for cooking.

As shown in FIGS. 1 and 2, the packaging material 140 containing the meat product 120 and support member 130 comprises optional indicia and/or writing 200 provided thereon. Such indicia and/or writing may include but is not limited to, for example, various product information, such as the name of the product, picture of the product, nutritional information, sales information, manufacturing information, use, freeze, or sell by dates, lot numbers information, cooking instructions, one or more recipes, one or more coupons, and/or promotional material.

An optional outer package may be placed at least partially around the packaging material 140 and provided with the various indicia described above. By way of example only, a laminated cardboard sleeve may be placed at least partially around an exterior surface of the packaging material 140 and used to display the writing. Alternatively, written material containing product information, cooking instructions, recipes, and/or coupons may be packaged with the meat product 120 and support member 130 either internally of the packaging material 140 or externally to the packaging material 140. In the latter case, the written material may be secured externally of the packaging material 140 via a suitable adhesive or other securing mechanism.

The meat product 120 and the support member 130 may each be enclosed by packaging material individually and then placed so the packaging material 140 encloses the meat product 120 and the support member 130 together. A material useful for providing protection to the kit 100 during shipping may be used, such as, for example, a cardboard envelope or the like configured to hold the kit 100 to protect the kit 100 during shipping. There are a variety of suitable known ways, including those typically used for packaging case-ready meat products, to package the meat product 120 and the support member 130 together for distribution (e.g., sale) as a packaged product, thereby facilitating purchase of the same by chefs at the point of sale.

Food product kits in accordance with the present invention may include one or more flavor enhancers, such as a spice, marinade, seasoning, and/or rub, for example, for flavoring a food product, such as, for example, the meat product 120. Such flavor enhancer(s) may be provided directly on the meat product 120 so a chef need not apply any additional spices to the meat product 120 prior to cooking the meat product 120 on the wooden support member 130. Alternatively or in addition, a flavor enhancer(s) may be provided in a packet and packaged together with the meat product 120 and the wooden support member 130, for example, within the packaging material 140 or external to the packaging material 140.

The meat product 120 may also optionally be flavored by being placed in a brine or other suitable flavoring or meat treating solution, as conventionally known. For example, the meat product 120 may be soaked in the solution prior to being packaged with the packaging material 140. Alternatively or in addition to soaking the meat product 120 prior to placing the meat product 120 in the packaging material 140, the solution may be disposed within a reservoir defined by the packaging material 140 and the meat product 120 and/or wooden support member 130 may be placed in the solution within the packaging material 140. In the latter circumstance, the packaging material 140 is preferably sealed (e.g., hermetically sealed), and the meat product 120 and/or the wooden support member 130 can at least partially absorb the solution while being disposed within the packaging material 140.

It may also be desirable to hydrate the wooden support member 130 within the packaging material 130 so that when it is desired to use the support member 130 for cooking the meat product 120 a chef does not need to hydrate the support member 130. The support member 130 may be hydrated in a hydrating liquid, such as, for example water or a brine or other known flavoring solution used for the meat product 120, prior to being placed within the packaging material 140 and/or may be hydrated via liquid absorption while within the packaging material 140. For example, as discussed above, a hydrating liquid, such as, for example, a brine solution, may be placed within a reservoir defined by the packaging material 140 and the support member 130 can at least partially absorb the hydrating liquid while provided within the packaging material 140.

In the case where a hydrating liquid (e.g., brine solution) is placed within the packaging material 140 and/or used to soak the meat product 120 and/or support member 130, the packaging material 140 is preferably sealed (e.g., hermetically sealed) so as to substantially prevent leakage of liquid from the packaging material 140 and/or evaporation of the liquid within the packaging material 140.

Exemplary hydrating liquids include any water-containing solution, suspension or emulsion intentionally contacted with the wood used to form the wooden support member. The term hydrating liquid, therefore, is not intended to refer to any water-containing solutions, suspensions or emulsions that may naturally be present in the wood at the time the tree from which such wood was obtained was cut down. Suitable hydrating liquids in accordance with the present invention, include, but are not limited to, liquids that add desirable flavors to food products that are cooked on the wooden support member such as, for example, fruit juices and extracts, vegetable juices and extracts, beer, wine, liquor, vinegar, brine solutions (comprising salt and/or sugar) used to flavor the food product (e.g., a meat product) sauces, barbecues, and combinations thereof. Alcohol and/or oil-containing hydrating liquids also may be used. However, alcohol and oil-containing hydrating liquids may increase the rate at which the wooden support member ignites if the wooden support member is not adequately protected from the heat source. Absorption of the hydrating liquid can be accomplished by a variety of techniques known to those skilled in the art, and, as described above, can occur before and/or after the wooden support member has been sealed in a package.

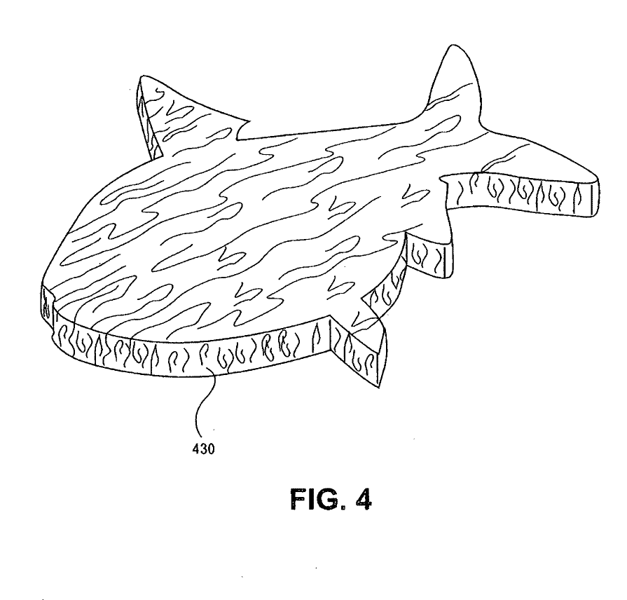

Although the wooden support member 130 may be in the form of a substantially planar plank, as shown in FIGS. 1 and 2, wooden support members having various other configurations are considered within the scope of the present invention. For example, the wooden support member may be arched so the surface of the support member on which the meat product is intended to lay is either convex or concave. Also, it is contemplated that wooden support members in accordance with the present invention may optionally comprise a design shape. FIG. 4 illustrates an exemplary embodiment of a wooden support member 430 having a design shape. In particular, the exemplary embodiment of FIG. 4 shows a wooden support member 430 in the shape of a fish.

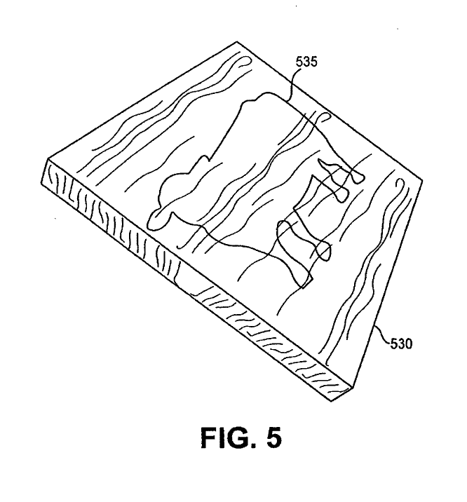

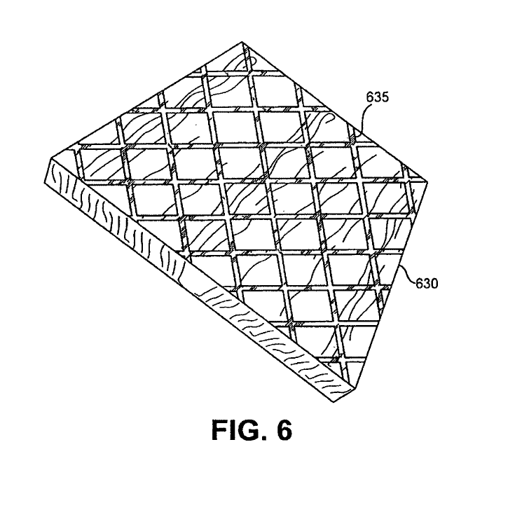

One or more surfaces of the wooden support member may optionally include a design and/or other surface feature provided thereon. FIG. 5 illustrates an exemplary wooden support member 530 having design 535 comprising a cow provided on a surface of the support member 530. FIG. 6 illustrates an exemplary wooden support member 630 having a surface feature in the form of a grill-like pattern of lines 635 which preferably functions to impart the look of grill lines onto the food product during cooking of the food product on the support member 630. Such a design or surface features provided on one or more surfaces of a support member, as shown in FIGS. 5 and 6 for example, may be achieved by a variety of techniques, including, for example, wood burning or branding, painting, carving, and/or other techniques those having ordinary skill in the art would appreciate.

The designs shown in FIGS. 4-6 are in no way intended to be limiting and those having skill in the art would appreciate that virtually any design, shape, or surface feature could be provided as desired. For example, the wooden support member could be circular, oval, rectangular, triangular, or other modified shape. Further, it is contemplated that a wooden support member in accordance with the present invention may be in the shape of a design and also have one or more surfaces provided with a design and/or other surface feature thereon. According to various embodiments, it may be desirable, although not necessary, for the design to be indicative of the type of food product that the wooden support member is provided with in a kit for performing plank cooking.

In general, wooden support members in accordance with the present invention have a first surface on which the food product rests while being supported by the wooden support member during cooking. For example, in the exemplary embodiments illustrated in FIGS. 1-3, the first surface is facing up and has the meat product 120 resting on such surface, and the second surface faces in a direction opposite to the first surface. The second opposite surface faces the heat source during cooking. The surface intended to face the heat source may be a smoke- and/or steam-generating surface as a result of being heated, including, for example, charring and/or burning, during cooking. The surface of the wooden support member on which the food product is intended to rest during cooking may optionally be provided with a basin for receiving food products for cooking. The basin preferably comprises a recessed area that can be formed by burning, charring, branding, carving or cutting the surface of the wooden support member using any conventional wood working method. Such a basin also may be configured for collecting liquids that may drip out of the food product during cooking or that may be applied to the food product before or during cooking. The basin also may keep the food product in contact with such liquids and prevent such liquids from flowing off the wooden support member and onto the heat source during cooking. The basin also may have an ornamental design shape.

As explained above, wooden support members in accordance with the present invention can be of any desired dimension and configuration. For example, the support members may have dimensions so as to fit on a conventional outdoor or indoor grill and/or in a conventional oven for cooking. For the purposes of cooking many food products, support members may have a length (e.g., dimension denoted L as exemplified in FIG. 2) ranging from about 8 inches to about 18 inches and a width (e.g., dimension denoted W as exemplified in FIG. 2) ranging from about 3.5 inches to about 10 inches. For example, in various embodiments, support members may have a length ranging from about 10 inches to about 12 inches and a width ranging from about 5 inches to about 6 inches. For support members having shapes other than substantially rectangular, the preceding dimensions may apply to the longest and widest portions of the support member, respectively. Irrespective of whether the dimensions correspond to those detailed above, the wooden support member is preferably dimensioned so as to extend beyond the perimeter of the food product resting on the support member during cooking. It may be desirable, for example, to dimension the wooden support member so any burning and/or charring around the edges of the support member that may occur during cooking will not cause drying and/or burning the food product near such edges.

Wooden support members preferably have a thickness (e.g., dimension denoted T as exemplified in FIG. 2) ranging from about ⅛ inch to about 1 inch. Irrespective of the thickness range provided above, the wooden support member preferably have a thickness sufficient to prevent burning therethrough, although it is contemplated that edges of the support member may char and/or burn and such charring and/or burning may be desirable for imparting flavor to the food product being cooked. In this case, while the surface of the support member facing the heat source during cooking may char and/or burn, the support member will not burn through the thickness of the support member so the food product resting on the opposite surface may be directly exposed to the heat source underneath the wooden support member. Wooden support members in accordance with the present invention are preferably substantially rigid, so the support members are able to support a food product, such as a meat product typically sold at the retail level to consumers, for example, without significantly bending or otherwise deforming. The wooden support member may be cut directly from a portion of a tree, or board, or the like, for example, and be made entirely of wood.

One or more chemical agents may optionally be provided within the packaging material used to enclose the food product and the wooden support member. For example, such chemical agents may be selected from any antimicrobial that is approved for use with food products. Such agents can be absorbed into the wooden support member together with a hydrating liquid or may be applied to the wooden support member separately before being placed within the packaging material. Chemical agents that inhibit or retard the growth of bacteria and/or mold within the packaging material during storage may be provided. Preferably, the amount of chemical agent used is sufficient to retard the growth of bacteria and/or mold for more than 180 days without any refrigeration, and more preferably, for an indefinite period of time. Benzoic acid and precursors thereof and/or sorbic acid and precursors thereof such as, for example, sodium benzoate, potassium sorbate, or a combination thereof, can be used for this purpose. Irradiation is another potential alternative to the use of chemical preservatives or in combination thereof. A gamma radiation source such as Cobalt 60 can be used to irradiate the packaged food product and wooden support member and thereby kill bacteria and/or microorganisms that may be present therein without harming the flavor of the wood or the hydrating liquid.

Another technique for inhibiting the growth of bacteria and/or fungus is to heat sterilize the wooden support member. This can be accomplished via conventional pasteurization or ultra-pasteurization processes, which are known to those having skill in the art. In this case, the appearance of the support member can be improved by sealing the wooden support member with a residual portion of hydrating liquid within the packaging material.

The wooden support member may optionally be pressure treated. Pressure treatment advantageously increases the mount of hydrating liquid that can be absorbed by the support member in a given period of time. The hydrating liquid absorbed by the wooden support member helps to increase the length of time the wooden support member can produce flavoring smoke and/or steam when positioned relative to a cooking heat source and also can help to increase the time the wooden support member will survive when exposed to high temperature. Furthermore, pressure treatment helps to facilitate the use of wooden support members that are relatively thin as compared to support members that have not been pressure treated. Pressure treatment can be accomplished in a number of ways, including, for example, forcing the support member to the bottom of a tall column of hydrating liquid. For example, a column of water 35 feet high produces a pressure of about 15 psi. Pressure treatment can also be accomplished using heat and pressure in a sealed vessel, such as can be produced using a pressure cooker, or using pressure without heat in a sealed vessel, such as can be produced using an autoclave.

An exemplary method of using an embodiment according to the present invention, for example, one of the exemplary embodiments depicted in FIGS. 1-3, is now described. After a chef desiring to plank cook obtains the packaged product, for example at a retail distributor, the packaging material 140 and any other optional material that is not intended for cooking (e.g., the tray 150, seasoning packets, written materials, additional packaging materials) is preferably separated from the meat product 120 and the support member 130. In their form as removed from the packaging material 140 and/or other material, it is envisioned that no additional preparation, including hydrating of the support member 130 and/or flavoring or otherwise preparing the meat product 120, is necessary. Rather, directly upon removal from the packaging associated with the support member 130 and meat product 120, the combined support member 130 and meat product 120 may be placed relative a heat source to cook the meat product 120. The heat source may be, for example, the burners or coals of an outdoor or indoor grill, or a conventional oven. It is envisioned that the heat source may have a temperature ranging from about 300° F. to about 600° F. For indoor or outdoor grills, the temperature may range from about 350° F. to about 600° F., and for conventional ovens, the temperature may range from about 350° F. to about 450° F.

The meat product 120 preferably need not be handled during the time period from removal from the packaging material 140 to placement of the support member 130 and meat product 120 relative to the heat source for cooking. However, the chef of course has the option of handling the meat product 120 to prepare the meat product 120 as desired for cooking. Moreover, it is considered within the scope of the present invention that a chef may optionally place other food products than that which is distributed together with the wooden support member 130 upon the support member 130 during cooking. When placed relative to the heat source, the surface of the wooden support member 130 that faces the heat source (i.e., the surface opposite the surface on which the meat product 120 rests) may smoke and steam, thereby producing flavoring and/or hydration to the meat product 120. Although heat may be transmitted through the thickness of the wooden support member 130 to the meat product 120 during cooking, the thickness of the support member 130 should be sufficient to protect the meat product 120 from direct exposure to the heat source to prevent excessive burning, charring, and/or drying of the meat product 120. Once the meat product 120 has been cooked as desired, the meat product 120 can be removed from the wooden support member 130 and served, or the wooden support member 130 may be used as a serving platter.

After being used once for cooking, for example, for cooking the meat product 120 with which the support member 130 is distributed, the wooden support member 130 may be disposed. However, it may be possible to use a wooden support member in accordance with the present invention more than once for cooking, depending, for example, on how thick the support member is, the degree to which the support member burns or chars during cooking, and other factors. Although wooden support members according to the present teachings may be directly exposed to heat from the heat source to cook the meat product, it is also envisioned that the wooden support members according to various embodiments may be used with a pan or other suitable cooking device. In this case, the wooden support member may be used more than once for cooking.

The present teachings provide a variety of structural arrangements, techniques, and/or methodologies useful for so-called plank cooking. It should be understood that although in some cases the embodiments described herein may focus on a particular aspect, various embodiments may be combined together. The various embodiments shown and/or described herein are not intended to be mutually exclusive.

It should be noted that sizes, configurations, shapes, numbers, and materials of various parts are illustrative and exemplary only. Those sizes, configurations, shapes, numbers, and materials can be changed to produce different effects and/or desired characteristics, without departing from the scope of the present invention. For example, although the exemplary embodiments illustrated in the drawings show a single food product and a single support member contained together to form a kit, it should be understood that more than one food product and/or more than one wooden support member may be distributed together. Wooden support members of differing wood species may be contained within a single packaged kit so that a chef may select the desired flavoring of the food product packaged with the support members. Also, more than one food product may be contained in the kit, for example, a plurality of differing or the same cuts of meat products may be provided together.

Further, although many of the embodiments described above have been discussed in conjunction with using wooden support members in the plank cooking of meat products, it should be understood that the exemplary techniques and systems disclosed herein may be used for cooking other food products, including, but not limited to, for example, vegetables, tofu, baked goods, and/or other type of food products for which plank cooking may be desirable. Also, it is envisioned that the exemplary embodiments may include either frozen or fresh food products. Thus, in FIGS. 1-3, the meat product 120 may be either fresh or frozen.

Other embodiments of the invention will be apparent, to those skilled in the art from consideration of the specification and practice of the invention disclosed herein. It is intended that the specification and examples be considered as exemplary only, with a true scope and spirit of the invention being indicated by the following claims.

What is claimed is:

1. A food product kit comprising:
a food product; and
a wooden support member, the support member being configured to support and provide flavor to the food product during cooking.

2. The kit of claim 1, further comprising a packaging material enclosing the food product and the support member.

3. The kit of claim 2, wherein the packaging material sealably encloses the food product and the support member.

4. The kit of claim 3, wherein the food product and the support member are vacuum sealed within the packaging material.

5. The kit of claim 1, further comprising at least one flavor enhancer for flavoring the food product.

6. The kit of claim 1, wherein the support member is hydrated.

7. The kit of claim 6, wherein the support member is hydrated by liquid used to flavor the food product.

8. The kit of claim 1, wherein the support member is made of a wood chosen from one or more of cedar, alder, apple, cherry, maple, pecan, hickory, and mesquite.

9. The kit of claim 1, wherein the support member comprises a plank.

10. The kit of claim 1, wherein the kit is configured to be disposable after use.

11. The kit of claim 1, wherein the support member is configured to be reusable.

12. The kit of claim 1, wherein the food product comprises a meat product.

13. The kit of claim 1, wherein the support member comprises a design or feature on a surface thereof.

14. The kit of claim 1, wherein the support member has a design shape.

15. The kit of claim 1, wherein the support member is configured to provide at least one of smoke and steam during cooking to flavor the food product.

16. The kit of claim 1, wherein the kit is case-ready for retail distribution.

17. A method for packaging a food product for retail distribution, the method comprising the steps of:
providing a food product;
providing a wooden support member configured to support and flavor the food product during cooking of the food product; and
packaging the support member and the food product together for retail distribution.

18. The method of claim 17, wherein the packaging comprises enclosing the food product and the support member with a packaging material.

19. The method of claim 17, wherein the step of enclosing the food product and the support member with a packaging material comprises enclosing the food product and the support member so as substantially prevent leakage of liquid.

20. The method of claim 19, wherein the step of enclosing the food product and the support member comprises vacuum sealing the food product and the support member.

21. The method of claim 17, further comprising providing at least one flavor enhancer for flavoring the food product and packaging the at least one flavor enhancer with the food product and the supporting member.

22. The method of claim 21, further comprising flavoring the food product with the at least one flavor enhancer.

23. The method of claim 17, further comprising hydrating the support member.

24. The method of claim 23, wherein the step of hydrating the support member comprises soaking the support member in a hydrating liquid prior to packaging the food product and the support member.

25. The method of claim 23, wherein the step of hydrating the support member comprises hydrating the support member with a liquid used to flavor the food product.

26. The method of claim 17, wherein providing the support member comprises providing a support member made of a wood chosen from cedar, alder, apple, cherry, maple, pecan, hickory, and mesquite.

27. The method of claim 17, wherein the providing the support member comprises providing a plank.

28. The method of claim 17, wherein providing the food product comprises providing a meat product.

29. A case ready packaged food product comprising:
a hydrated wooden support member;
a food product positioned on a surface of the hydrated wooden support member; and
a vacuum sealed package enclosing the hydrated wooden support member and the food product.

30. The packaged food product of claim 29, further comprising at least one flavor enhancer.

31. The packaged food product of claim 29, wherein the support member is made of a wood chosen from one or more of cedar, alder, apple, cherry, maple, pecan, hickory, and mesquite.

32. The packaged food product of claim 29, wherein the food product comprises a meat product.
